(19) United States
(12) Patent Application Publication
(10) Pub. No.: US 2026/0077960 A1
(43) Pub. Date: Mar. 19, 2026

(54) DEVICE AND METHOD FOR SEPARATING PARTS

(71) Applicant: Finatec Holding AG, Brügg b. Biel (CH)

(72) Inventors: Daniel STERN, Worben (CH); Nicola Silvan GAUTSCHI, Aarberg (CH); Beat SCHLUP, Biberist (CH)

(21) Appl. No.: 19/109,464

(22) PCT Filed: Aug. 31, 2023
(86) PCT No.: PCT/EP2023/073934

§ 371 Date: Mar. 6, 2025

(30) Foreign Application Priority Data
Sep. 8, 2022 (CH) CH001041/2022

(51) Int. Cl. B65G 47/29; B65G 21/20; B65G 47/88

(52) U.S. Cl. CPC B65G 47/295; B65G 21/2036; B65G 47/8823; B65G 47/8876

(57) ABSTRACT

Method and device (1) for separating parts (2), for example rotationally symmetrical closures, containers and/or preforms, the device comprising a transport apparatus (10) by means of which the parts (2) to be conveyed are able to be conveyed to, through or out of the device (1) along a transport path (16) in a transport direction (11), the transport apparatus (10) having at least one transport means (12) for transporting the parts (2) in one row and an accumulation section (13); and a blocking assembly (20) comprising at least one blocking element (20.1; 20.2) which is in the form of a rocker and the length of which extends in the transport direction (11), which blocking element defines a range of action W for the parts (2). The device (1) further comprises an actuator (30). The actuator (30) is designed to pivot the at least one blocking element (20.1; 20.2) into a first position in which a part (2.1) advancing into the range of action W is held back, and to pivot said at least one blocking element from the first position into a second position in which the advancing part (2.1) is able to be received within the range of action W.

### TECHNICAL FIELD OF THE INVENTION

The invention relates to a device and a method for separating parts, in particular rotationally symmetrical closures, containers and/or preforms. The separating device is particularly used in connection with a testing device for optical and/or electrical testing of rotationally symmetrical test specimens.

### STATE OF THE ART

It is known that mass-produced test specimens are continuously subjected to an inspection for quality assurance purposes in order to detect properties and/or defects in the test specimens. The test specimens can be closures of containers, containers or bottles or so-called preforms produced in large numbers, which are generally fed to an optical inspection device in a row via an accumulation section by means of a conveyor. Detectable defects can be, for example, dimensional defects, material defects and color defects, whereby the optical inspection is sensibly performed on individual test specimens. Accordingly, a separating device can be provided between the accumulation section and the optical inspection device so that an analyzable image of the separated test specimens can be taken by a processing device in order to detect defective test specimens.

However, it may also be necessary to separate the parts in other respects, which are brought forward adjacent to each other along a transport direction by means of conveyor means. Subsequent processing of the parts, for example printing, may require the parts to be conveyed to a processing zone at a distance from each other.

Devices for separating parts are already known. For example, the use of a star wheel with several fingers that plunge into objects open at the top is known. By adjusting the rotational speed of the star wheel relative to the feed speed of a conveyor belt, it is possible to create a gap of an adjustable size between the objects behind the star wheel, i.e. to separate the objects. Alternatively, pocket wheels arranged on both sides of the transport direction with pockets arranged along the circumference are known, which can be brought into engagement with the test objects. The pocket wheels are rotated synchronously in opposite directions, whereby the peripheral speed is lower relative to the speed of the conveying means so that the test objects to be picked up can continue to be transported separately.

Another principle for separating, conveying and buffering adjacent parts is known from CH 704 843. Here, objects are separated by means of a plurality of rocker-type pivoting blocking elements arranged in series along a conveyor path. The objects conveyed by means of frictional connection cause a rocking movement of the blocking elements, i.e. the blocking elements are moved passively and therefore without a drive. When an object leaves the blocking element, it deflects it in such a way that a subsequent object is stopped. If the preceding object has left a range of action of the blocking element, the blocking element performs a counter-movement so that the stop is canceled.

### SUMMARY OF INVENTION

It is an object of the present invention to provide a device for separating parts, in particular rotationally symmetrical closures, containers and/or preforms, whereby buffering and positioning of the parts before, during and/or after separation is improved and, in particular, adjustable. This means that the device for separating can also be combined with an inspection of the parts. Based on an adjustable and possibly controllable separation of the parts by means of the separating device, an optical and/or electrical inspection for detecting faulty parts can be carried out easily and reliably in the periphery of this device. However, defects can also be detected and resolved during conveying and/or the number of separated parts can be recorded by means of the separating device. A method for separating parts is also described.

These objects are achieved according to the invention in particular through the subject matter of the independent claims. Further advantageous embodiments follow moreover from the dependent claims and the description.

The objects of the present invention are achieved by a device for separating parts, for example rotationally symmetrical closures, containers and/or preforms, comprising a transport apparatus, by means of which the parts to be conveyed can be conveyed to, through and out of the device along a transport path in a transport direction, the transport apparatus comprising at least one transport means for transporting the parts in a single row and an accumulation section, a blocking assembly with at least one blocking element of rocker-type design, which extends with a length along the transport direction and defines a range of action for the parts. The device further comprises an actuator. The actuator is set up to pivot the at least one blocking element into a first position, in which a part advancing into the range of action is held back, and to pivot said at least one blocking element from the first position into a second position in which the advancing part is receivable within the range of action. In the first position, which can also be referred to as the blocking position, the blocking element projects with one end region into the transport path, against which the advancing part strikes and is stopped. The at least one blocking element is therefore deflected in the first position. In the second position, a release position, the advancing part is located in the range of action and is released for further transportation by renewed pivoting of the blocking element into a third position, a release position, which largely corresponds to the first position.

The rocking-type and pivoting blocking element of the blocking assembly can be designed as a lever arm with a certain length, which can be pivoted about a pivot axis by means of an articulation. The pivot axis is perpendicular to the transport direction, so that a rocking movement of the blocking element into and out of the transport path results. The two ends of the blocking element thereby perform the opposite movement with respect to each other in accordance with the pivot movement. A stop can be formed on one side of the blocking element, which interacts with an actuator (or another component) that is arranged laterally facing the blocking element. This can also limit the range of movement of the blocking element, i.e. the deflection range.

A control unit can be provided in order to switch the actuator in a predeterminable defined work cycle.

In contrast to the known devices for separating parts, in which the pivoting movement is injected by the conveyed part itself, i.e. passively, the device according to the invention uses an actuator to pivot the at least one blocking element, which is designed in the form of a rocker, between the positions. Accordingly, based on the prior art, the device is further developed in such a way that the passive execution of the rocking movement of at least one blocking element according to the invention can be actively executed by the actuator. Preferably, the device can also comprise a control unit which is set up to activate the actuator in a definable work cycle or to control it.

In known passive designs, the object conveyed by a transport means presses on one end of the blocking element of rocker-type design, whereby this deflects in such a way that a subsequent object is stopped. Only when the first object leaves the range of action of the rocker-type blocking element can the following object push the blocking element in the opposite direction again, thereby canceling the stop. The distance between consecutive objects can only be controlled via the conveying speed of the transport means. Multiple blocking elements are arranged along the transport path to stop the objects again and again. This passive design proves to be disadvantageous and in particular prone to malfunction, as well as not being very flexible in construction.

In contrast, the device according to the invention not only allows parts to be safely separated and the holding time of stationary parts to be freely selected by means of the actuator or its controlled switching, but also the distance between successive parts can be easily set and adjusted. Accordingly, the actuator is designed and/or arranged as an activation element for the blocking element of rocker-type design in order to transfer it selectively between a blocking and a release configuration. In addition, separation by means of a blocking element of rocker-type design proves to be gentler on the parts, as force is only applied via the less sensitive outer surface of the round parts.

According to one embodiment of the invention, the blocking assembly comprises rocker-type blocking elements arranged on both sides of the transport path, i.e. a first blocking element and a second blocking element arranged opposite each other, which can be actuated synchronously by means of one or more actuators. The first blocking element and the second blocking element act like a pincer, which in the first position is more or less closed for an advancing part, so that the part pushing or advancing between the blocking elements is held back. This position of the blocking elements is referred to below as the first position or locking position and, according to one embodiment, can be actively switched by the actuator and, in particular, released. In a holding position defined as the second position, the advancing part is in the ranges of action of the blocking elements. The holding time of these positions can be defined and set by means of the control unit via the switching of the actuator. If the blocking elements are pivoted into a third position, i.e. a release position, through interaction with the actuator, the part located in the range of action is released. In the third position, the blocking elements assume the same position as in the first position.

In principle, it is conceivable that certain positions of the at least one blocking element are not actively switched by the actuator, but that the blocking element or the blocking elements are forced into the position by advancing parts.

Alternatively, the actuator can also be designed and/or arranged so that a blocking position is present in its switched-off state. In a subsequent phase, a part that pushes forward can either advance into the range of action of the at least one blocking element due to the dynamic pressure, which then assumes the second position. According to one embodiment, the path for the advancing part is opened by the activated actuator and held or stopped in this position by the position of the at least one blocking element.

Active execution of the pivoting movement by the actuator(s) allows the pivoting movement to be controlled independently of the prevailing pressure of the accumulated parts. Accordingly, homogeneous separation of the parts to be conveyed is possible, which also tolerates gaps and/or disturbances in the accumulation section. When parts are conveyed in bulk, disruptions to the flow of parts can occur, particularly upstream of the separating device, e.g. due to parts that do not conform to specifications. This can be detected by sensors, for example. Active control of the pivoting movement of the blocking element by the switchable actuator allows possible blockages to be cleared. In addition, a jam in the device or in the inlet area of the device can be cleared in that the at least one blocking element is actively pivoted into an open position or the second position until the jam has cleared.

To detect problems, especially in the accumulation section, a sensor can be provided, in particular an optoelectrical sensor, which can monitor this area. If an improper jam or gap occurs in this area, a control signal can be transmitted to the actuator located downstream in order to rectify the problem by switching the blocking element appropriately.

In a further embodiment of the device for separating parts, in which the blocking assembly comprises a first blocking element and an oppositely disposed second blocking element, an opening width between the two oppositely disposed rocker-type blocking elements is variable, in particular the opening width can be adapted to the diameter of rotationally symmetrical parts. This adjustability allows the separating device to be easily adapted to different parts without having to replace the blocking elements for this purpose.

In a preferred embodiment of the device for separating parts, the actuator is set up to magnetically cause the at least one rocker-type blocking element to pivot. For this purpose, the actuator can be designed as a switchable electromagnet or have one that interacts with an end region of the rocker-type blocking element in the switched-on state. This can be done, for example, by means of an appropriately arranged magnetic means. The electromagnet can be subjected to alternating voltage, rectified alternating voltage or pulses generated from direct voltage and thus exert a periodically alternating force on the means. Accordingly, the at least one rocker-type blocking element is pivoted. The blocking element can be moved by the laterally arranged switchable electromagnet, whereby the at least one rocker-type and pivotable blocking element is pivoted into the first or third position or into the second position. When the electromagnet is switched off or de-energized, the blocking element pivots in the opposite direction.

Alternatively, the actuator can also be designed as a mechanical actuator. This can comprise a movable plunger which can be moved in the direction of the blocking element. Thus, in this embodiment, one end of the blocking element can rest against the displaceable plunger and be moved with it in such a way that it can be moved into the first or third position and the second position.

Furthermore, the actuator can be designed to cause the pivot axis of the at least one blocking element of the blocking assembly to pivot via an activated rotation. One conceivable variant for such an actuator is an electric motor.

The actuator can be controlled by a controller and a control method with adaptive functions in a closed control loop or an open control path, and can be moved to intermediate and/or end positions. By means of a controllable switching of the actuator, e.g. of the electromagnet, not only the position of the rocker-type blocking element can be actively determined, but also the separation can be timed and/or the distance between separated parts can be set via the timing of the switching.

Advantageously, the blocking element can strike the actuator in a damped manner. In one embodiment, for this purpose, a magnetic field can be set in such a way that the movement of the blocking element in the direction of the actuator is slowed down.

A work cycle is possible solely by switching the actuator, which is designed as an electromagnet, or also by means of a return spring. The pressure force of the accumulated parts pushing into the separating device forces the blocking elements into the holding position, whereby the actuator or the electromagnet actively delays the opening.

In a further embodiment, the actuator is switchable to hold the blocking element in the first position, the blocking position, during an adjustable holding time, whereby the transportation of the parts through the device is stopped. Furthermore, the actuator can be switchable to hold the blocking element in the second position, the holding position, during an adjustable holding time, whereby a part received in the range of action of the blocking element is held fast.

In a further embodiment, the distance between successive parts along the transport direction downstream of the device can be adjusted by means of the actuator.

In one embodiment of the invention, the number of pivoting movements actively initiated by the actuator can be recorded by means of a sensor. In this way, it is possible to easily detect the number of parts passing through the device for separating parts based on the number of switching operations of the actuator. It also proves to be advantageous that counting the number of parts passing through the separating device allows transport boxes etc. to be filled precisely, whereby, for example, the flow of parts can be diverted or fed to a buffer device when a certain number of parts is reached.

According to one embodiment, the transport apparatus, which conveys parts to, through and out of the separating device, comprises at least one transport means designed as a belt conveyor. The belt conveyor can have a conveyor belt, round belts or other circulating transport means which are suitable for transmitting driving forces to the parts to be conveyed by means of frictional forces.

Preferably, the belt conveyor is designed as a vacuum belt conveyor. A vacuum belt conveyor increases the contact pressure of the parts on the surface of the transport medium or the conveyor belt and stabilizes the position of the parts to be conveyed. This means that the slip between the surface of the conveyor belt and the parts to be conveyed can be increased, which is advantageous for the design of the transport apparatus. It is conceivable that only a section of the transport path, in particular the area corresponding to the range of action of the blocking element, is designed as a vacuum conveyor. Alternatively or additionally, at least in the inlet area of the transport apparatus, e.g. in the accumulation section, a compressed air conveyor can also be provided.

To counter the problem that the relative movement between the transport apparatus and the part to be conveyed can cause damage to the parts due to friction, the transport means should be designed accordingly for friction-reduced transportation, at least in the area of the accumulation section. Vacuum conveying or coating of the transport level is suitable, for example.

In order to arrange the parts in a single row in contact with one another, at least in the accumulation section or a section upstream of the separating device, lateral limits running in the transport direction can be arranged parallel to one another above the transport path in such a way that the parts are preferably guided on opposite sides of the lateral surface of the parts. This prevents individual parts from deviating from the single-row arrangement due to the prevailing accumulation pressure.

The arrangement, shape or dimension of the at least one rocker-type blocking element can be adapted to the shape or length of the parts perpendicular to the direction of transport. By adapting the arrangement and/or shape of the blocking element, it is thus possible to easily adapt the separating device to different parts. In this way, the flexibility of the separating device for parts with different dimensions can be further improved. High parts have an elongated shape along their axis so that they protrude with a certain height above the surface of the transport means. An adaptation or a correspondingly higher positioning or an arrangement above the transport apparatus of the at least one blocking element also allows reliable separation for this high part shape thanks to a correspondingly enlarged contact surface.

In order to provide as friction-reducing a contact area as possible between the rocker-type blocking element and the part, bearing means, e.g. ball bearing elements, can be provided on the contact surfaces of the blocking element with the part to be separated. This leads to less friction on the contact surfaces and thus to a reduction in wear. This means that transport through the separating device can take place at high speed and with extreme precision with minimal friction. As an alternative or in addition to the at least one bearing means, a friction-reducing coating can be provided on the contact area. A high-speed feed with a capacity of up to around 4500 parts per minute or an optimum throughput is conceivable.

According to one embodiment of the invention, the actuator can be switched in such a way that at least one of the parts is at a standstill during a definable holding time. This state can be useful to close any detected gaps in the flow of parts. Furthermore, this stoppage, which can be generated and adjusted during a customizable holding time, can be used to carry out an optical inspection and/or an electrical inspection of the parts for flaws by means of one or more testing devices. The holding time, which can be set using the actuator, can be adapted to the requirements of the test method used, or the test can be synchronized with the separation or pivoting movement of the blocking element. The test can be selected from a variety of test methods, in particular an optical test method and/or a high-voltage test.

Preferably, the optical inspection of the parts can be based on an image of the part, which is taken using an image recording device. The image can then be evaluated by a processing device in such a way that defective parts are detected. A comprehensive optical inspection can be used to check the performance of a closure or a container, for example to check the integrity of a tamper-proof band, a closure thread and/or a sealing element.

Alternatively and/or additionally, the conveyed part can be subjected to an electrical test to detect holes and/or cracks. A high-voltage test is suitable for this purpose. In particular, the high-voltage test can be carried out by applying a pulsed voltage from a voltage source. A correspondingly designed testing device comprises an electrode arrangement with an upper electrode arranged above the transport plane and a lower electrode arranged below the transport plane, between which a discharge path is formed. An applied test voltage is greater than or equal to the breakdown voltage between the electrodes in air, but less than the breakdown voltage through a defect-free part between the electrodes.

It is particularly advantageous if a transport means designed as a conveyor belt has holes or openings that are arranged at a certain distance from each other in the transport direction. For example, a vacuum belt conveyor has such holes. These holes or openings are designed and arranged in such a way that during the high-voltage test the discharge path between the upper electrode and the lower electrode runs through one of the holes or openings and thus not through a potential insulator, for example the conveyor belt.

The combination of separation and inspection proves to be particularly advantageous with regard to part-by-part tracking of the parts along the transport path. For example, a part identified as faulty can be tracked using encoders for position and/or path measurement and sorted out at the end of the transport path.

Furthermore, detected defects, such as micro-holes and/or micro-cracks detected during a high-voltage test, for example, can be recorded in statistics and combined with the results of other test methods. Defective parts can be assigned to their injection molding cavity in the mold and a targeted correction is possible at an early stage.

The present invention also relates to a method for separating parts, for example of rotationally symmetrical closures, containers and/or preforms, which can advantageously be carried out by means of the device for separating according to the invention. The method comprises transporting parts along a transport path by means of a transport apparatus, whereby the parts can be arranged in a single row and adjacent to one another along an accumulation section in front of the apparatus. Furthermore, the method comprises pivoting a rocker-type blocking element into a first position by means of an actuator, which blocking element extends with a length along the transport direction and defines a range of action for the parts, whereby a part is prevented from entering the range of action, pivoting into a second position, in which the entering part can be received in the range of action, and pivoting the rocker-type blocking element into a third position, which corresponds to the first position, whereby the path for the part in the transport direction is released. This part leaves the range of action of the blocking element at a distance from the preceding part.

In a preferred embodiment of the method, the pivoting of the blocking element from one position to the other is delayed by a certain time, by an adjustable holding time. This holding time, which can be set by controlling the actuator, allows the distance between individual parts to be set easily. Accordingly, the distance between two parts that are allowed to pass through in a synchronized way can be adjusted.

The parts separated by the device can persist in a stationary position either before or during the separation. According to one embodiment of the method, the method for separating can be combined with an optical and/or electrical testing method of the parts, which are preferably at a standstill, by means of a correspondingly designed optical and/or electrical testing device.

Further details of the invention emerge from the following description of the preferred embodiments, which are illustrated by way of example in the accompanying drawings. The further advantages of the present invention may be gleaned from the description as well as suggestions and proposals as to how the inventive subject matter can be changed within the scope of what is claimed or also further developed.

### BRIEF DESCRIPTION OF THE DRAWINGS

FIG. 1 shows a schematic perspective representation of a device for separating parts according to the invention;

FIG. 2 shows a schematic sectional view of the device for separating parts according to the invention in one embodiment;

FIG. 3 shows a schematic perspective representation of a detail of the device for separating parts according to the invention in combination with a testing device;

FIG. 4A shows a schematic view of a device for separating round parts according to one embodiment in a first phase;

FIG. 4B shows a schematic view of the device for separating round parts in a second phase;

FIG. 4C shows a schematic view of the device for separating round parts in a third phase;

FIG. 5 shows a schematic view of the device for separating round parts in a further embodiment.

### PREFERRED EMBODIMENTS OF THE INVENTION

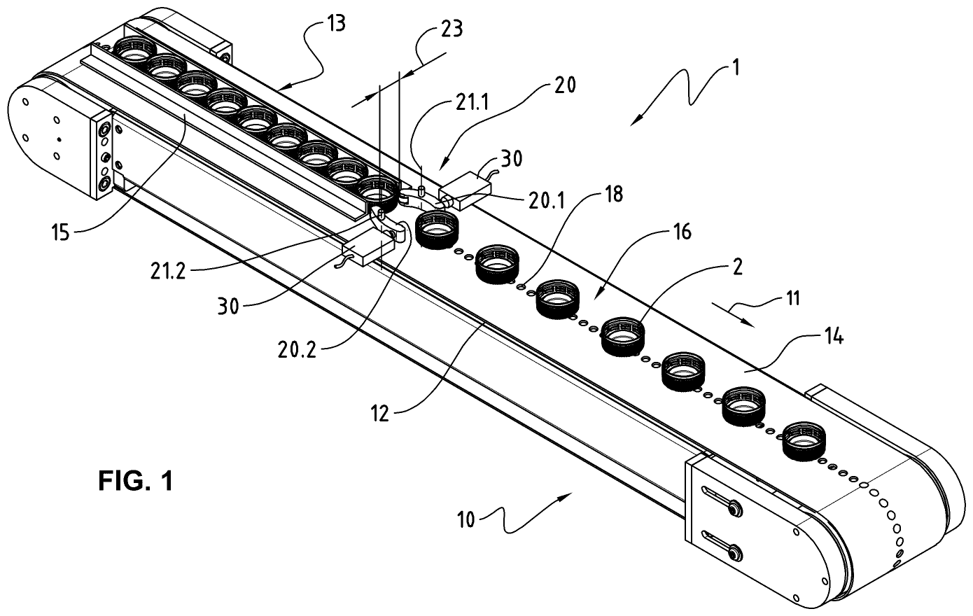

FIG. 1 shows a schematic perspective view of a device 1 according to the invention for separating parts, for example rotationally symmetrical parts 2, such as closures of beverage containers. The parts 2 are largely identical objects produced in large numbers, for example closures as shown. The device 1 for separating parts is also referred to as separating device 1. The separating device 1 is designed to separate parts 2 from one another that are transported by a transport apparatus 10 in a transport direction 11 along a transport path 16. The parts 2 are fed by transport means 12 and accumulated in at least sections of an accumulation section 13 in such a way that they are arranged in a single row and adjacent to one another on a transport level 14. On the transport level 14, the parts 2 are transported from the transport means 12 through the separating device 1 and on to subsequent devices. The transport means 12 can have belt conveyors, vacuum belt conveyors or the like in order to convey the parts 2 along the transport path 16 in the transport direction 11. Details of the transport means 12, such as the supporting structure, drive unit and/or deflection unit for a conveyor belt and possibly a sliding plate, are not shown for the sake of clarity. Preferably, a negative pressure or a vacuum can be applied, which acts on the parts 2 via slots or openings 18 of the transport means 12. The openings 18 also prove to be advantageous with regard to an electrical test, since an insulator conveyor belt is eliminated during a high-voltage test, for example.

Above the transport level 14, lateral guides 15 extending parallel to each other at least in the area of the accumulation section 13 are arranged in such a way that the transported parts 2 are guided on opposite sides, for example of the lateral surface, and thus assume a single-row and abutting order. By means of the transport apparatus 10, the separating device 1 can be connected to upstream and/or downstream devices.

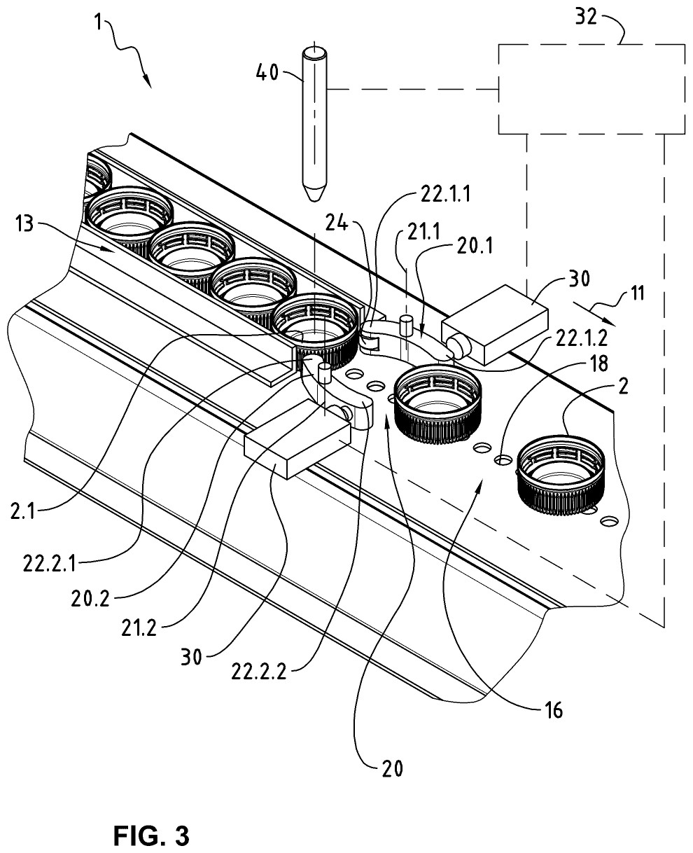

The separating device 1 according to the invention in the embodiment shown has a blocking assembly 20, comprising a first blocking element 20.1 and a second blocking element 20.2, which are arranged opposite one another above the transport level 14. Each of the blocking elements 20.1, 20.2 is mounted on an articulation in such a way that it is pivotable about a pivot axis 21 perpendicular to the transport level 14, as can be seen in FIG. 3. The first blocking element 20.1 and the second blocking element 20.2 are actively actuated by an actuator 30. In doing so, the blocking element 20.1 and the blocking element 20.2 are each pivoted about their pivot axes 21.1; 21.2, i.e. deflected in such a way that they either project into the transport path 16 or are pivoted out of it. Details of the blocking assembly 20 are shown in FIG. 3.

The pivoting of each of the two blocking elements 20.1, 20.2 does not take place passively, but actively and synchronized via the actuator 30, in particular via a controllable electromagnet. Accordingly, the actuator 30 causes the continuously fed parts 2 lying next to each other to execute a synchronized movement along the transport path 16 by stopping them by the two blocking elements 20.1, 20.2, the stop being effected by the blocking assembly 20 which can be pivoted by the actuator 30. Furthermore, the pivoting movement of each of the blocking elements 20.1, 20.2 of the blocking assembly 20, timed by the actuator 30, enables an appropriate reaction to blockages of parts which do not meet the specification and/or gaps along the transport path 16. In the case of an interrupted flow of parts in transport direction 11, the blockage can be released by an automatic moving apart of the blocking elements 20.1, 20.2. Furthermore, by detecting the position of the blocking assembly 20 and/or a positionable part trigger sensor (not shown), a jam can be detected and transmitted to a control unit 32 (not shown) of the separating device 1. To clear the jam, an opening width 23 between the opposing first blocking element 20.1 and second blocking element 20.2 of the blocking assembly 20 can be increased, for example, so that the parts 2 are released from the blockage, the jam clears and the flow of parts is uninterrupted. Alternatively or additionally, a compressed air nozzle provided (not shown) could be activated in order to sort the blocking parts 2 out of the flow of parts. So that downstream devices, e.g. testing devices, are not influenced, the control unit 32 can transmit a corresponding signal to them, which indicates the beginning and/or end of a flow of defective parts.

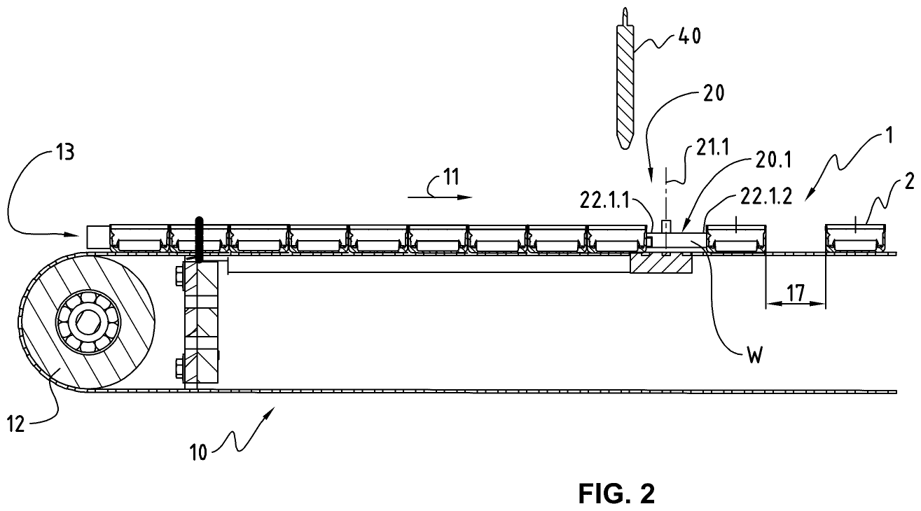

FIG. 2 shows a schematic sectional view of the separating device 1. The parts 2 are transported along the transport direction 11 into, through and out of the separating device 1. They thereby pass the blocking assembly 20 with the first blocking element 20.1 and the second blocking element 20.2. The first blocking element 20.1 has a first end 22.1.1 and a second end 22.1.2; the second blocking element 20.2 therefore has a first end 22.2.1 and a second end 22.2.2. The first blocking element 20.1 and the second blocking element 20.2 each extend along the transport direction with a length, so that a range of action W is created in each case. Each of the blocking elements 20.1, 20.2 can be pivoted about the respective pivot axis 21.1; 21.2, whereby the actuator 30 initiates the pivoting movement. The timed pivoting movement of the blocking elements 20.1, 20.2 separates the parts so that successive parts 2 are spaced apart by a distance 17, which is adjustable.

In FIG. 2, details of the transport device 10 are visible, comprising a transport means 13 designed as a belt conveyor with corresponding drive rollers and a conveyor belt. Also indicated is a testing device 40, which will be described below.

FIG. 3 shows a perspective view of a section of the separating device 1 in one embodiment with two opposing blocking elements 20.1 and 20.2, which can be pivoted about their pivot axes 21.1; 21.2 in a synchronized manner by means of the actuator 30 or several actuators 30. When one of the first blocking elements 20.1 and/or the second blocking element 20.2 pivots about its respective pivot axis 21.1 or 21.2, the first end 22.1.1 and the second end 22.1.2 of the first blocking element 20.1 and/or the first end 22.2.1 and the second end 22.2.2 of the second blocking element 20.2 each perform an opposite movement with respect to the transport path 16. The blocking assembly 20 extends with a length along the transport direction 11 and defines in each case the range of action W between the first end 22.1.1 and the second end 22.1.2 of the first blocking element 20.1 and the first end 22.2.1 and the second end 22.2.2 of the second blocking element 20.2. The first end 22.1.1 of the first blocking element 20.1 and the first end 22.2.1 of the second blocking element 20.2 of the blocking assembly 20 are in contact with the part 2.1, which pushes into the respective range of action W. A bearing means 24 is provided in each case at the first end 22.1.1 of the first blocking element 20.1 and the first end 22.2.1 of the second blocking element 20.2 of the blocking assembly 20, which reduces the friction during a relative movement of the part 2.1 along the first end 22.1.1 of the blocking element 20.1 or the first end 22.2.1 of the second blocking element 20.2. It is shown that the part 2.1, which is currently at a standstill, can be checked optically and/or electrically for defects by means of the indicated testing device 40. Shown is a high-voltage test of part 2.1. for detecting micro-holes and/or micro-cracks which, for example, impair the tightness of a closure. Advantageously, the test procedure is timed synchronously with the rocking movement of the first blocking element 20.1 and/or the second blocking element 20.2 of the blocking assembly 20 and, in particular, is adapted to the switching of the actuator 30 and can be controlled.

Indicated in FIG. 3 by 32 is a control unit, which controls at least the actuator 30 and/or the testing device 40.

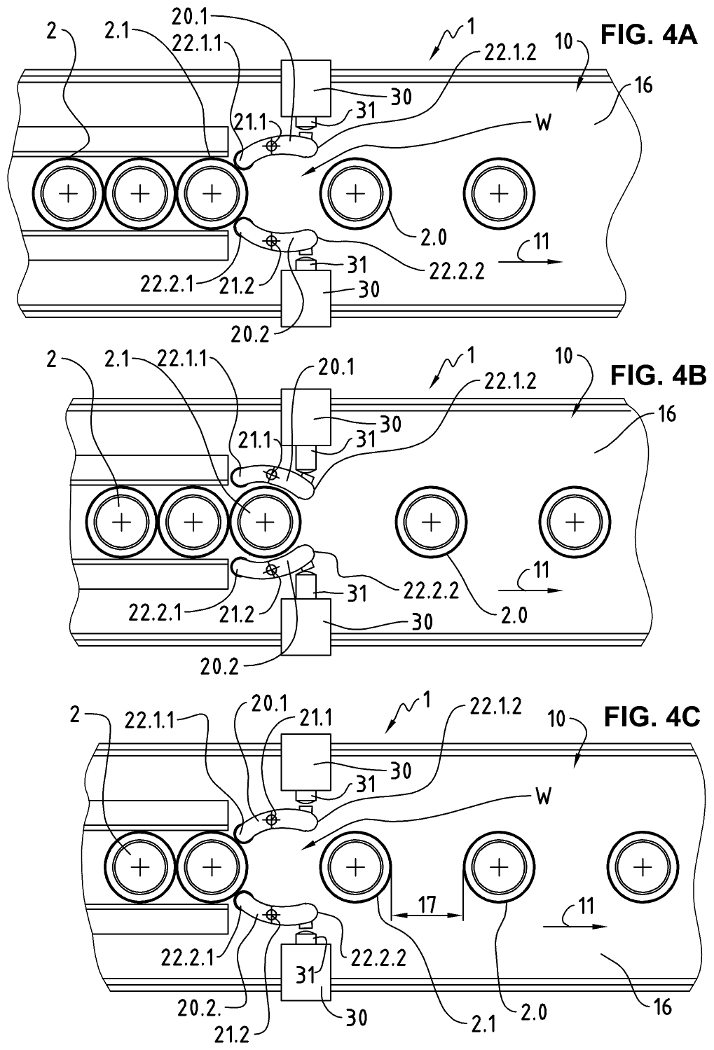

FIG. 4A shows a first phase in a schematic view of the separating device 1. Here, the actuator 30 comprises a displaceable plunger 31 which, in the embodiment shown, can be brought into interaction with the second end 22.1.2 of the first blocking element 20.1 or the second end 22.2.2 of the second blocking element 20.2. However, it is also conceivable that the actuator 30 is in interaction with the first end 22.1.1 of the first blocking element 20.1 and/or the first end of the second blocking element 20.2. In the first phase shown, the opposing first and second blocking elements 20.1; 20.2 of the blocking assembly 20 are pivoted into a first position about the respective pivot axis 21.1 and 21.2 when the actuator 30 is activated. In this first position, a blocking configuration is present in which the advancing part 2.1 is pressed against the first end 22.1.1 of the blocking element 20.1 and the first end 22.2.1 of the second blocking element 20.2 of the blocking assembly 20 and is stopped. Accordingly, in this first position, the transport path 16 is blocked for the advancing part 2.1. The part 2.1 at the front, as seen in the transport direction 11, is stopped, as are the subsequent parts 2.

In FIG. 4B, the first end 22.1.1 of the first blocking element 20.1 and the first end 22.2.1 of the opposite second blocking element 20.2 of the blocking assembly 20 are moved apart and thus clear the way for the advancing part 2.1, which can be accommodated in the respective ranges of action W of the first blocking element 20.1 and the second blocking element 20.2. The part 2.1 is stopped by the rear second end 22.1.2 of the first blocking element 20.1 and the second end 22.2.2 of the second blocking element 20.2 as seen in the transport direction 11. The thus completed movement of the first blocking element 20.1 and/or the second blocking element 20.2 can be varied manually or automatically, whereby the opening width 23 (see FIG. 1) between the first blocking element 20.1 and the second blocking element 20.2 is also adjustable. Parts 2 with different diameters can therefore be separated without having to replace the blocking assembly 20 as a whole. The second position of the first blocking element 20.1 and/or the second blocking element 20.2, which can be designated as the holding position, can be maintained for an adjustable holding time. The holding time corresponds approximately to the cycle time between two switching operations of the actuator 30. Both during the blocking position and during the holding position, at least one of the parts 2 is at a standstill. In FIG. 4B, this is at least part 2.1, which is included in the respective range of action W. In FIG. 4A, this is the part 2.1 which is in contact with the first end 20.1.1 of the first blocking element 20.1 and/or the first end 20.2.1 of the second blocking element 20.2 in this first position.

In FIG. 4C, a subsequent third phase of the separating device 1 is shown. In this third phase, the first blocking element 20.1 and the second blocking element 20.2 of the blocking assembly 20 are in a third position, the release position, which corresponds to the first position, the blocking position. Here, the first blocking element 20.1 and the second blocking element 20.2 are pivoted by the actuator 30 in such a way that the part 2.1 is released and conveyed by the transport apparatus 10 further in the transport direction 11 at a defined distance 17 from the preceding part 2.0.

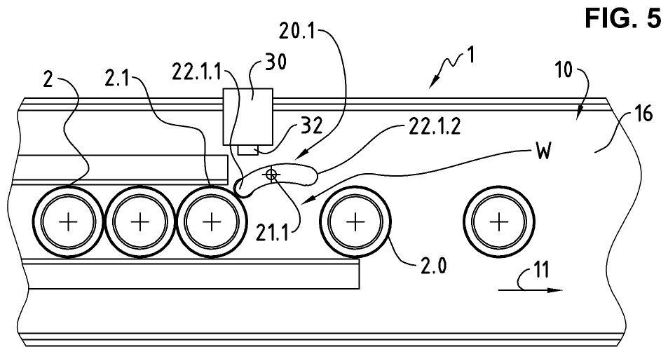

In FIG. 5, a further embodiment of the separating device 1 is shown. In this embodiment, the blocking assembly 20 comprises a blocking element 20.1, which is designed such that it is pivotable about its pivot axis 21.1 and, in the different positions, causes a part 2.1 entering and leaving its range of action W to be stopped and held and released. As shown, the actuator 30 comprises an electromagnet 32 which, in the embodiment shown, can be brought into interaction with the first end 22.1.1 of the first blocking element 20.1 or a magnetic means provided thereon. However, it is also conceivable that the actuator 30 comprises a displaceable plunger 31, which interacts with the first end 22.1.1 of the first blocking element 20.1. Depending on the design and the arrangement of the actuator 30 relative to the pivot axis 21.1 of the blocking element 20.1, a blocking position or the other positions are initiated in its active or passive state.

1. Device for separating parts, comprising
a transport apparatus, by means of which the parts to be conveyed are able to be conveyed to, through or out of the device along a transport path in a transport direction, the transport apparatus having at least one transport means for transporting the parts in one row and an accumulation section,
a blocking assembly comprising at least one blocking element which is in the form of a rocker and the length of which extends in the transport direction, which blocking element defines a range of action W for the parts,
wherein the device further comprises an actuator, the actuator being set up to pivot the at least one blocking element into a first position in which a part advancing into the range of action W is held back, and to pivot said at least one blocking element from the first position into a second position in which the advancing part is able to be received within the range of action W.

2. Device for separating parts according to claim 1, wherein the device further comprises a control unit, which is set up to switch the actuator into a definable work cycle.

3. Device for separating parts according to claim 1, wherein the blocking assembly comprises, disposed laterally with respect to the transport path, a first blocking element and an oppositely positioned second blocking element, which are able to be actuated synchronously by the actuator.

4. Device for separating parts according to claim 3, wherein an opening width between the first blocking element and the second blocking element is adaptable to a diameter of the parts.

5. Device for separating parts according to claim 1, wherein the actuator is set up to bring about magnetically or mechanically a pivoting of the at least one blocking element of the blocking assembly.

6. Device for separating parts according to claim 1, wherein the actuator is set up to bring about a rotation of a rotation axis of the at least one blocking element of the blocking assembly.

7. Device for separating parts according to claim 1, wherein the actuator is switchable in order to hold the at least one blocking element of the blocking assembly in the first position during an adjustable holding time, the transportation of the parts by the device being stopped.

8. Device for separating parts according to claim 1, wherein the actuator is switchable in order to hold the at least one blocking element of the blocking assembly in the second position during an adjustable holding time, whereby a part received in the range of action (W) of the blocking assembly is held fast.

9. Device for separating parts according to claim 1, wherein the actuator is switchable in order to adjust a spacing between successive parts after the device.

10. Device for separating parts according to claim 1, wherein a sensor is included in order to determine the number of parts conveyed through the device.

11. Device for separating parts according to claim 1, wherein the transport apparatus comprises at least one transport means designed as a conveyor belt.

12. Device for separating parts according to claim 11, wherein the conveyor belt is a vacuum conveyor.

13. Device for separating parts according to claim 1, wherein the parts in the accumulation section are able to be transported actively by means of compressed air or conveyor belt.

14. Device for separating parts according to claim 1, wherein the at least one blocking element is able to be arranged and/or designed in such a way so as to be able to be brought into engagement with high parts.

15. Device for separating parts according to claim 1, wherein bearing means are arranged on contact surfaces between the at least one blocking element and part.

16. Device for separating parts according to claim 1, comprising a testing device in order to inspect parts which are at a standstill for defects by means of an optical and/or electrical test, the test being carried out in the work cycle of the pivoting movement of the at least one blocking element.

17. Device for separating parts according to claim 16, wherein the testing device for an optical test comprises an image recording and/or for an electrical test a high-voltage device.

18. Method for separating parts, comprising
a) transporting parts along a transport path by means of a transport apparatus, whereby the parts are able to be arranged in a single row and adjacent to one another along an accumulation section in front of the device,
b) pivoting of a blocking element in the form of a rocker into a first position by means of an actuator, which blocking element extends with a length along the transport direction and defines a range of action (W) for the parts, whereby a part is prevented from entering the range of action (W),
c) pivoting of the blocking element, which is designed in the manner of a rocker, into a second position by means of the actuator, in which the part can be received in the range of action (W), and
d) pivoting the blocking element designed in the form of a rocker into the first position, whereby the part is released in the transport direction.

19. Method for separating parts according to claim 18, comprising between the steps a) and b) or between the steps b) and c) an adjustable stop period, the length of which is able to be determined by the actuator.

20. Method for separating parts according to claim 18, wherein before or during the separation an optical and/or electrical testing of the parts that are at a standstill is able to be carried out by means of a testing device.
